(19) United States
(12) Patent Application Publication
(10) Pub. No.: US 2025/0380833 A1
(43) Pub. Date: Dec. 18, 2025

(54) APPLIANCE STEAM AND HEAT DISPERSING SYSTEM

(71) Applicant: Gerald Laurendine, Emporia, KS (US)

(72) Inventor: Gerald Laurendine, Emporia, KS (US)

(21) Appl. No.: 19/226,831

(22) Filed: Jun. 3, 2025

Related U.S. Application Data
(60) Provisional application No. 63/659,609, filed on Jun. 13, 2024.

(51) Int. Cl. A47J 31/44; A47J 31/52; F04D 27/00

(52) U.S. Cl. CPC A47J 31/4403; A47J 31/525; F04D 27/00; A47J 2202/00

(57) ABSTRACT

An appliance steam and heat dispersion system, wherein the system comprises a steam and heat dispersion fan structured and operable to generate forced air to disperse steam and heat generated by an appliance away from the appliance, and a fan control unit structured and operable to detect operation of the appliance and activate the steam and heat dispersion fan upon detection of the operation of the appliance.

### CROSS-REFERENCE TO RELATED APPLICATIONS

This application claims the benefit of U.S. Provisional Application No. 63/659,609, filed on Jun. 13, 2024, the disclosure of which is incorporated herein by reference in its entirety.

### FIELD

The present teachings relate to steam generating appliances such as coffee pots, and more particularly to an automatic system and method for dispersing steam and/or heat generated by such appliances.

### BACKGROUND

The statements in this section merely provide background information related to the present disclosure and may not constitute prior art.

Various home appliances such as coffee pots, air fryers, toasters, toaster ovens are often designed to be placed on countertops, e.g., kitchen countertops, such that the appliance is disposed or placed under cabinets disposed above the countertop. In many instances the operation of such home appliances produces steam and/or heat that due to convection currents rises and contacts the cabinets disposed above the respective appliance. Prolonged and/or continuous exposure of such steam and/or heat can cause damage (e.g., discoloration and deterioration of the cabinet finish/coating, material and construction).

### SUMMARY

In various embodiments, the present disclosure provides an appliance steam and heat dispersion system, wherein the system comprises a steam and heat dispersion fan structured and operable to generate forced air to disperse steam and heat generated by an appliance away from the appliance, and a fan control unit structured and operable to detect operation of the appliance and activate the steam and heat dispersion fan upon detection of the operation of the appliance.

In various other embodiments, the present disclosure provides a steam and heat dispersion fan control unit that is structured and operable to detect operation of an appliance removably connectable thereto and to activate a steam and heat dispersion fan removably connectable thereto upon detection of the operation of the appliance. In various instances, the steam and heat dispersion fan control unit comprises an appliance operation and monitoring module that is structured and operable to detect operation of the appliance, and a timer module that is communicatively connected to the appliance operation and monitoring module. The timer module is structured and operable to receive a trigger signal from the appliance operation and monitoring module and activate a steam and heat dispersion fan upon detection of the operation of the appliance. The steam and heat dispersion fan is structured and operable to generate forced air to disperse the at least one of steam and heat generated by an appliance away from the appliance.

In yet other embodiments, the present disclosure provides an appliance that generates at least one of steam and heat during operation and is structured and operable to generate forced air to disperse the at least one of steam and heat away from the appliance. In various instances the appliance comprises appliance electronics and an appliance steam and heat dispersion system, wherein the appliance steam and heat dispersion system comprises a steam and heat dispersion fan that is structured and operable to generate forced air to disperse the at least one of steam and heat generated by an appliance away from the appliance. The appliance steam and heat dispersion system additionally comprises a fan control unit that is structured and operable to detect operation of the appliance and activate the steam and heat dispersion fan upon detection of the operation of the appliance.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### BRIEF DESCRIPTION OF DRAWINGS

The drawings described herein are for illustration purposes only and are not intended to limit the scope of the present teachings in any way.

FIG. 1 is an exemplary illustration of an appliance steam and/or heat dispersion system, in accordance with various embodiments of the present disclosure.

FIG. 2 is an exemplary illustration of the appliance steam and/or heat dispersion system shown in FIG. 1, in accordance with various other embodiments of the present disclosure.

FIG. 3 is an exemplary general electrical schematic of a fan control unit of the appliance steam and/or heat dispersion system shown in FIGS. 1 and 2, in accordance with various embodiments of the present disclosure.

FIG. 4 is an exemplary illustration of the appliance steam and/or heat dispersion system shown in FIGS. 1, 2 and 3 incorporated as part of or integrated into a steam and/or heat generating appliance, in accordance with various other embodiments of the present disclosure.

FIG. 5 is an exemplary general electrical schematic of the appliance steam and/or heat dispersion system incorporated as part of or integrated into a steam and/or heat generating appliance as shown in FIG. 4, wherein a timer module of the fan control unit comprises a fan timer board, in accordance with various embodiments of the present disclosure.

FIG. 6 is an exemplary general electrical schematic of the appliance steam and/or heat dispersion system incorporated as part of or integrated into a steam and/or heat generating appliance as shown in FIG. 4, wherein the timer module of the fan control unit comprises a thermal sensor, in accordance with various embodiments of the present disclosure.

Corresponding reference numerals indicate corresponding parts throughout the several views of drawings.

### DETAILED DESCRIPTION

The following description is merely exemplary in nature and is in no way intended to limit the present teachings, application, or uses. Throughout this specification, like reference numerals will be used to refer to like elements. Additionally, the embodiments disclosed below are not intended to be exhaustive or to limit the invention to the precise forms disclosed in the following detailed description. Rather, the embodiments are chosen and described so that others skilled in the art can utilize their teachings. As well, it should be understood that the drawings are intended to illustrate and plainly disclose presently envisioned embodiments to one of skill in the art, but are not intended to be manufacturing level drawings or renditions of final products and may include simplified conceptual views to facilitate understanding or explanation. As well, the relative size and arrangement of the components may differ from that shown and still operate within the spirit of the invention.

As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims.

Unless otherwise defined, all technical and scientific terms used herein have the same meaning as commonly understood by one of ordinary skill in the art to which this disclosure belongs. The terminology used herein is for the purpose of describing particular example embodiments only and is not intended to be limiting. As used herein, the singular forms “a”, “an”, and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps can be employed.

When an element, object, device, apparatus, component, region or section, etc., is referred to as being “on”, “engaged to or with”, “connected to or with”, or “coupled to or with” another element, object, device, apparatus, component, region or section, etc., it can be directly on, engaged, connected or coupled to or with the other element, object, device, apparatus, component, region or section, etc., or intervening elements, objects, devices, apparatuses, components, regions or sections, etc., can be present. In contrast, when an element, object, device, apparatus, component, region or section, etc., is referred to as being “directly on”, “directly engaged to”, “directly connected to”, or “directly coupled to” another element, object, device, apparatus, component, region or section, etc., there may be no intervening elements, objects, devices, apparatuses, components, regions or sections, etc., present. Other words used to describe the relationship between elements, objects, devices, apparatuses, components, regions or sections, etc., should be interpreted in a like fashion (e.g., “between” versus “directly between”, “adjacent” versus “directly adjacent”, etc.).

As used herein the phrase “operably connected to” will be understood to mean two are more elements, objects, devices, apparatuses, components, etc., that are directly or indirectly connected to each other in an operational and/or cooperative manner such that operation or function of at least one of the elements, objects, devices, apparatuses, components, etc., imparts or causes operation or function of at least one other of the elements, objects, devices, apparatuses, components, etc. Such imparting or causing of operation or function can be unilateral or bilateral.

As used herein, the term “and/or” includes any and all combinations of one or more of the associated listed items. For example, A and/or B includes A alone, or B alone, or both A and B.

Although the terms first, second, third, etc. can be used herein to describe various elements, objects, devices, apparatuses, components, regions or sections, etc., these elements, objects, devices, apparatuses, components, regions or sections, etc., should not be limited by these terms. These terms may be used only to distinguish one element, object, device, apparatus, component, region or section, etc., from another element, object, device, apparatus, component, region or section, etc., and do not necessarily imply a sequence or order unless clearly indicated by the context.

Moreover, it will be understood that various directions such as “upper”, “lower”, “bottom”, “top”, “left”, “right”, “first”, “second” and so forth are made only with respect to explanation in conjunction with the drawings, and that components may be oriented differently, for instance, during transportation and manufacturing as well as operation. Because many varying and different embodiments may be made within the scope of the concept(s) taught herein, and because many modifications may be made in the embodiments described herein, it is to be understood that the details herein are to be interpreted as illustrative and non-limiting.

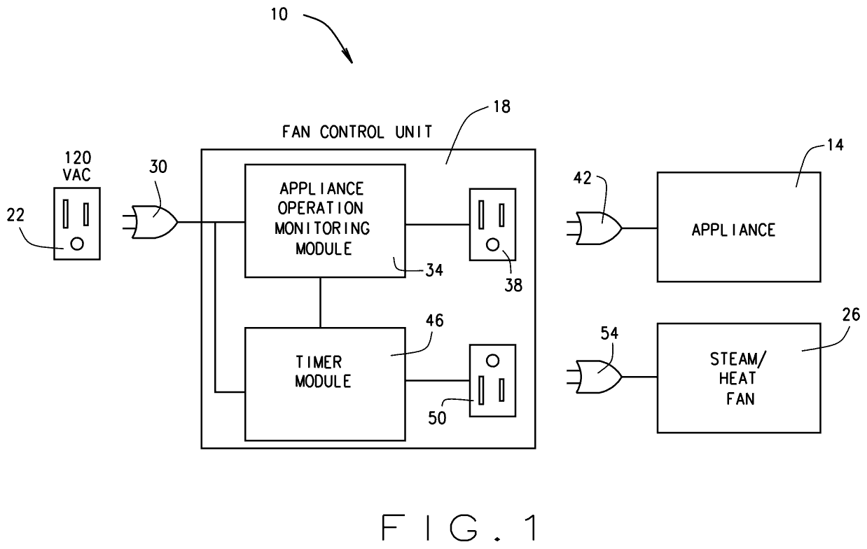

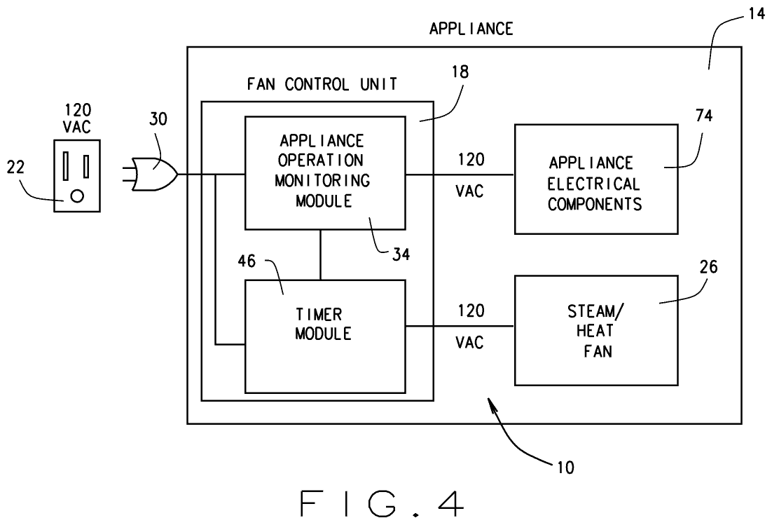

Referring to FIGS. 1, 2, 3, 4, 5 and 6, the present disclosure generally provides an appliance steam and/or heat dispersion system 10 structured and operable to direct and disperse steam and/or heat generated by an appliance 14 via forced air. The appliance 10 can be any appliance that generates or emits steam and/or heat and/or oily vapors during operation. For example, the appliance 14 can be a coffee maker, air fryer, toaster, toaster oven, vegetable/rice steamer, pressure cooker, crock pot, roaster, etc. The appliance steam and/or heat dispersion system 10 comprises a fan control unit 18 and a steam/heat dispersion fan 26. The steam/heat dispersion fan 26 is structured and operable to generate forced air to cool and disperse steam and heat generated by the appliance 14 away from the appliance 14 and more particularly away from cabinets or any other object disposed above or near or adjacent or in close proximity to the appliance 14. The fan control unit 18 is structured and operable to detect operation of the appliance 14 and activate or initiate operation of the steam/heat dispersion fan 26. In various instances, the fan control unit 18 generally comprises an appliance operation and monitoring module 34 and a timer module 46 that is communicatively connected to the appliance operation and monitoring module 34 via electrical connection, or wireless connection. In various embodiments, the appliance steam and/or heat dispersion system 10 (i.e., the fan control unit 18 and the steam/heat dispersion fan 26) can be separate and independent from the appliance 14, as exemplarily illustrated in FIGS. 1, 2 and 3, while in other embodiments, the appliance steam and/or heat dispersion system 10 (i.e., the fan control unit 18 and the steam/heat dispersion fan 26) can be components of, integrated with or incorporated as part of, or integrally formed with the appliance 14, as exemplarily illustrated in FIGS. 4, 5 and 6.

Referring now to FIGS. 1, 2 and 3 wherein the fan control unit 18 and steam/heat dispersion fan 26 are separate and independent from the appliance 14. In various instances of such embodiments the appliance operation and monitoring module 34 can comprise a current sensing module. In such embodiments the fan control unit 18 is removably electrically connectable to a voltage supply source 22 (e.g., a standard 120 V electrical wall outlet) via a fan control unit supply source connector 30 (e.g., a standard electrical device cord and plug). The fan control unit 18 comprises the appliance operation monitoring/current sensing module 34 that is electrically connected between the fan control unit supply source connector 30 and an appliance outlet 38 that is structured and operable to receive an appliance connector 42 (e.g., a standard electrical device cord and plug), which is the voltage input (Vin) of the appliance 14. The appliance operation monitoring/current sensing module 34 is structured and operable to provide an electrical current flow path between the fan control unit supply source connector 30 and the appliance outlet 38, and more particularly between the voltage supply source 22 and the appliance 14 when the fan control unit 18 is electrically connected to the voltage supply source 22 and the appliance 14 is connected to the fan control unit appliance outlet 38. Furthermore, the appliance operation monitoring/current sensing module 34 is structured and operable to sense and monitor the level or strength (e.g., amperage) of electrical current flowing therethrough when the fan control unit 18 is electrically connected to the voltage supply source 22 and the appliance 14 is connected to the fan control unit appliance outlet 38.

The fan control unit 18 additionally comprises the timer module 46 that is electrically connected between the fan control unit supply source connector 30 and a steam/heat fan outlet 50 that is structured and operable to receive a stem/heat fan connector 54 (e.g., a standard electrical device cord and plug) that is the voltage input (Vin) of the steam/heat dispersion fan 26. The timer module is additionally communicatively connected to the appliance operation monitoring/current sensing module 34 (via electrical connection, or wireless connection) that is structured and operable to send a trigger signal to the timer module 46 when the current flowing through the appliance operation monitoring/current sensing module 34, more particularly the current flowing between the voltage supply source 22 and the appliance 14 exceeds a preset, or in various instances a user adjustable or programmable, current trigger limit (e.g., exceed 10 A). The timer module 46 is structured and operable to provide an electrical current flow path between the fan control unit supply source connector 30 and the steam/heat fan outlet 50, and more particularly between the voltage supply source 22 and the steam/heat dispersion fan 26 when the fan control unit 18 is electrically connected to the voltage supply source 22, the steam/heat dispersion fan 26 is connected to the steam/heat fan outlet 50, and the timer module 46 has been triggered or activated to a closed circuit configuration via the trigger signal from the appliance operation monitoring/current sensing module 34, as described below.

As described above, in the various embodiments wherein the fan control unit 18 and the steam/heat dispersion fan 26 are separate and independent from the appliance 14, the fan control unit 18 is removably electrically connectable to the voltage supply source 22 and the appliance 14 and the steam heat dispersion fan 26 are removably electrically connectable to the fan control unit 18 such that during operation of the fan control unit 18 the fan control unit 18 will provide electrical power (e.g., 120 volts alternating current (VAC)) to the appliance 14, as described below. Particularly, when the appliance connector 42 is connected to (e.g., plugged into) the fan control unit appliance outlet 38, the steam/heat connector 54 is connected to (e.g., plugged into) the steam/heat fan outlet 50, the fan control unit supply source connector 30 is connected to (e.g., plugged into) the voltage supply source 22, and the appliance 14 is turned on/operating (e.g., when “brewing” is initiated with a coffee maker), the appliance 14 will draw high current (e.g., approx. 10 amps) from the voltage supply source 22. The high current will flow through the fan control unit 18 (more particularly flow through the appliance operation monitoring/current sensing module 34) to the appliance 14, more specifically, to the electrical component(s) of the appliance 14 (e.g., the heating element and hot plate of a coffee maker). The appliance operation monitoring/current sensing module 34 monitors the current flowing through the fan control unit 18 (more particularly the current flowing through the appliance operation monitoring/current sensing module 34) and subsequently sends a trigger signal to the timer module 46 when the appliance operation monitoring/current sensing module 34 senses or detects that the amount of current being drawn therethrough exceeds the current trigger limit, i.e., a predetermined current threshold (e.g., approx. 6, 8, 10, 12, etc. amps).

When the timer module 46 receives the trigger signal, the timer module 46 is initiated and completes an electrical pathway from the voltage supply source 22 to steam/heat fan outlet 50, and more particularly to the steam/heat dispersion fan 26 that is connected (plugged into) the steam/heat fan outlet 50 via the steam/heat connector 54, thereby initiating operation of the steam/heat dispersion fan 26 for a preset or predetermined fan-on time cycle or duration (e.g., approx. 20 minutes), as controlled by the timer module 46. When the steam/heat dispersion fan 26 is positioned to cool and disperse and direct steam and/or heat away from the appliance 14 and more particularly away from cabinets or any other object disposed above or near or adjacent or in close proximity to the appliance 14. For example, the steam/heat dispersion fan 26 will disperse the upward convection flow steam and/or heat from the appliance 14 and cool and direct the steam and/or heat away from cabinets or any other object disposed above or near or adjacent or in close proximity to the appliance 14.

At the end of the fan-on preset time cycle or duration the timer module 46 interrupts, terminates, ceases or discontinues the flow of current therethrough, thereby ceasing the voltage being supplied to the steam/heat dispersion fan 26 and turning off operation of the steam/heat dispersion fan 26. In various embodiments, the timer module 46 can be configured to have a fixed preset/predetermined fan-on time cycle or duration (such as 20 minutes) for which the timer module 46 provides current to the steam/heat fan outlet 50, and more particularly to the steam/heat fan 26. In alternative embodiments, the timer module 46 can be configured to have a user adjustable or programmable variable fan-on time cycle or duration, such that the timer module 46 can be set or programmed to by the application user to have a user controlled fan-on time cycle or duration (e.g., 10, 20, 30, etc. minutes). Once the appliance 14 and steam/heat dispersion fan 26 are electrically connected to the fan control unit 18 (e.g., plugged in to respective appliance and steam/heat fan outlets 38 and 50 of the fan control unit 18) the operation of the appliance steam and/or heat dispersion system 10 is fully automatic and is initiated and/or reinitiated each time the appliance 14 is used (e.g., each time the coffee maker begins brewing).

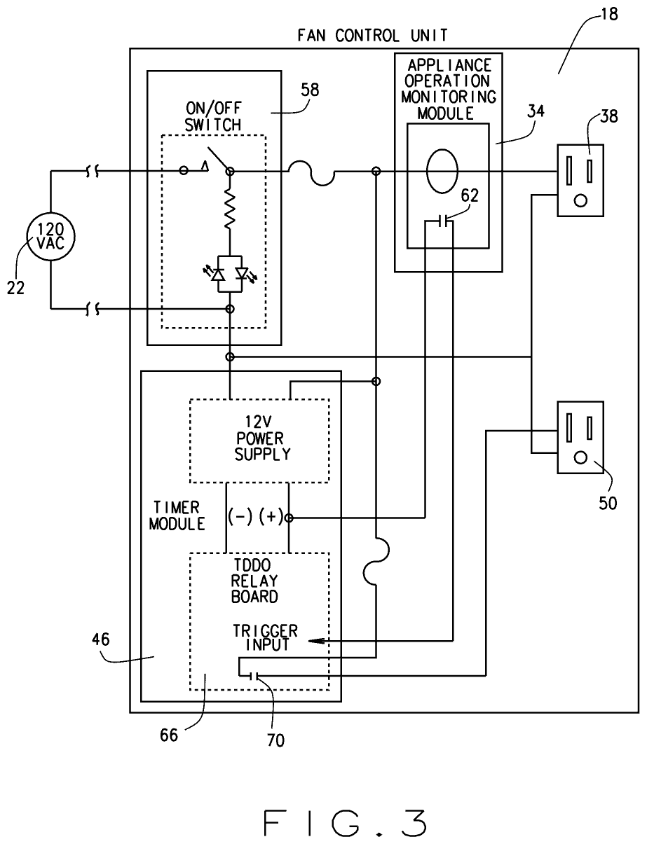

Referring particularly to FIG. 3, in various embodiments, the fan control unit 18 can include an ON/OFF switch 58 that controls the provision of electrical power (e.g., the flow of current) from the voltage supply 22 to the appliance outlet 38 (via the appliance operation monitoring/current monitoring module 34) and the steam/heat fan outlet 50 (via the timer module 46) when the fan control unit 18 is connected to (e.g., plugged into) the voltage supply source 22 via the fan control unit supply source connector 30. More specifically, when the fan control unit 18 is connected to (e.g., plugged into) the voltage supply source 22 and the ON/OFF switch 58 is in an ON position, current is allowed to flow from the voltage supply source 22 to the appliance outlet 38 (via the appliance operation monitoring/current sensing module 34) and the steam/heat fan outlet 50 (via the timer module 46), and hence to the appliance 14 and the steam/heat dispersion fan 26 as described above. However, when the fan control unit 18 is connected to (e.g., plugged into) the voltage supply source 22 and the ON/OFF switch 58 is in an OFF position, current is prevented from flowing from the voltage supply source 22 to the appliance outlet 38 (via the current monitoring module 34) and the steam/heat fan outlet 50 (via the timer module 46), and hence to the appliance 14 and the steam/heat dispersion fan 26. In various embodiments, the ON/OFF switch can be a lighted or illuminating switch that lights or illuminates when fan control unit supply source connector 30 is connected to (e.g., plugged into) the voltage supply source 22 and the ON/OFF switch 58 is in the ON position.

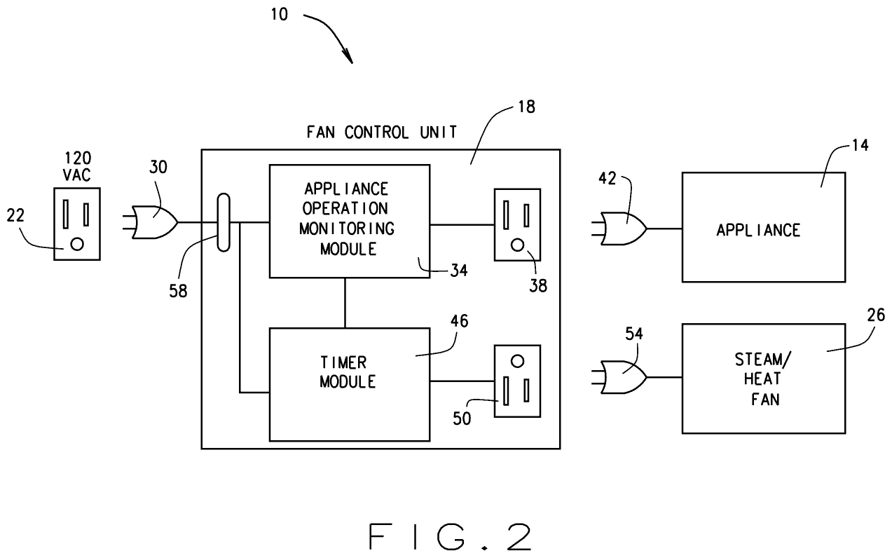

FIG. 3 provides an exemplary basic electrical schematic of the fan control unit 18 in accordance with various embodiments of the present disclosure. Generally electrical power (e.g., 120 VAC) is provided to the fan control unit 18 via the voltage supply source 22. As described above, in various instances, the electrical power (e.g., 120 VAC) is provided to the fan control unit 18 through the ON/OFF switch 58 to the appliance outlet 38 of the fan control unit 18 via the appliance operation monitoring/current sensing module 34. In various embodiments the current trigger limit of the appliance operation monitoring/current sensing module 34 can be user adjustable or programmable In various instances, the appliance operation monitoring/current sensing module 34 can be configured to sense and monitor current by the magnetic flux associated with electrical current flow. When the appliance 14 is electrically connected to fan control unit 18 (e.g. plugged into the appliance outlet 38 via the appliance connector 42, shown in FIG. 2), and the current trigger limit or threshold is exceeded (e.g., approx. 10 amps is exceeded), as detected by the appliance operation monitoring/current sensing module 34, in various instances the appliance operation monitoring/current sensing module 34 closes output contacts 62 thereof. In various instances, closing the output contacts sends the trigger signal (e.g., a trigger voltage such as a +12 volt signal) to thereby trigger a time delay drop out (TDDO) relay board 66 of the timer module 46. The TDDO relay board is structured and operable to control the flow of current through the timer module 46 to the steam/heat fan outlet 50, and more particularly to the steam/heat fan 26, and further to control a fan-on time cycle or duration of the flow of current to the steam/heat fan outlet 50. In such instances, upon receipt of the trigger signal the TDDO relay board 66 closes output contacts 70 thereof for the fan-on time cycle or duration. When the TDDO relay board 66 closes the output contacts 70, 120 VAC is supplied to the steam/heat fan outlet 50. As described above, the steam/heat dispersion fan 26 connected to (e.g., plugged into) the steam/heat fan outlet 50 is positioned or pointed to cool and disperse and direct steam and/or away from the appliance 14 and more particularly away from cabinets and/or other surfaces disposed above or near or adjacent or in close proximity to the appliance 14, thereby dispersing the steam and/or heat and thus preventing steam and/or heat from damaging such surfaces.

At the end of the fan-on time cycle or duration, the TDDO relay board 66 opens the output contacts 70, thereby terminating or removing the current flowing to the steam/heat fan outlet 50 and turning off the steam/heat dispersion fan 26. Once the appliance 14 and steam/heat dispersion fan 26 are connected to (e.g., plugged into) their respective appliance and steam/heat fan outlets 38 and 50, the operation of the appliance steam and/or heat dispersion system 10 is fully automatic and is initiated and/or reinitiated each time operation of the appliance 14 is initiated. As described above, in various instances the current monitoring module 34 trigger limit or threshold is adjustable and the TDDO relay board fan-on time durations are adjustable.

For simplicity of understanding the present disclosure is generally directed to steam and/or heat emitted from the appliance 14 during and immediately following operation of a coffee maker. However, the present disclosure is not to be interpreted as being limiting in the use of this appliance steam and/or heat dispersion system 10 to coffee makers only. The appliance steam and/or heat dispersion system 10 as disclosed herein can also be used for steam and/or heat emissions from other devices such as, but not limited to, air fryers, toasters, toaster ovens, vegetable/rice steamers, pressure cookers, crock pots, roasters, etc. or industry processes where it is desirable for steam and/or heat and/or other vapors to be cooled and removed/directed away from surrounding areas.

Referring now to FIGS. 4, 5 and 6, as described above, in various embodiments, the appliance steam and/or heat dispersion system 10 (i.e., the fan control unit 18 and the steam/heat dispersion fan 26) can be incorporated as part of or integrated within the appliance 14. More particularly, the fan control unit 18 is internally integrated with the appliance electronics 74 within the appliance 14, and the steam/heat dispersion fan 26 can be either interiorly integrated or disposed within a housing of the appliance 14 or exteriorly integrated or disposed (e.g., mounted or connected to) within an exterior of the housing of the appliance 14. Optionally, the appliance 14 can be configured to have an appliance outlet, such as appliance outlet 38, exteriorly integrated with or disposed within the exterior housing of the appliance 14, to which a steam/heat fan (as described above) can be connected.

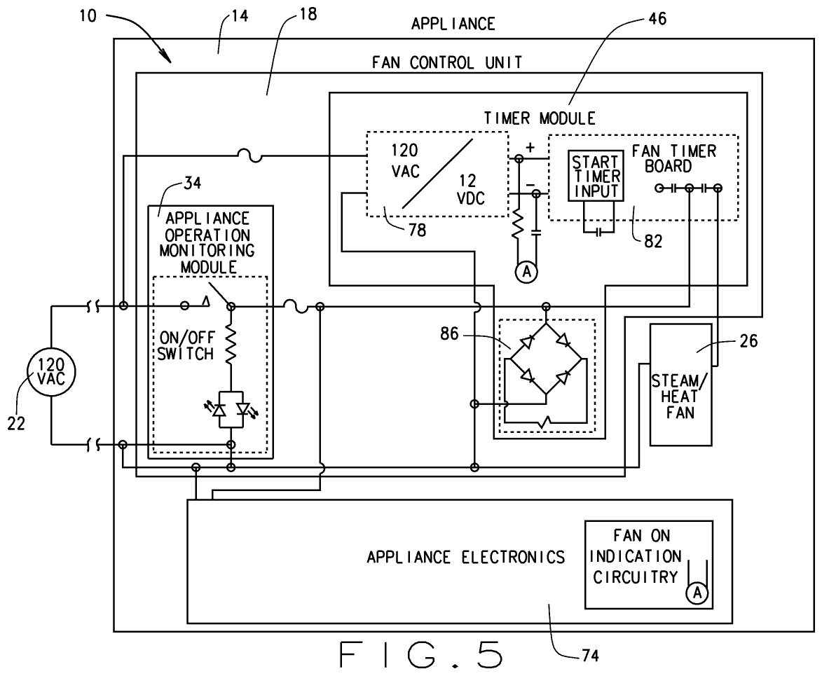

FIG. 5 provides an exemplary basic electrical schematic of the fan control unit 18 and steam/heat dispersion fan 26 are integrated into the appliance 14 in accordance with various embodiments of the present disclosure. In various instances of such embodiments the appliance operation and monitoring module 34 can comprise an appliance ON/OFF switch (e.g., a light indicating start switch), and the timer module 46 can comprise a power supply 78 (e.g., a 12 VDC power supply) a fan timer board 82 and a relay and bridge rectifier 86. The appliance ON/OFF switch is generally operable to provide electrical current to appliance electronics such as the heating element, water pump and hot plate of a coffee maker. Additionally, in such embodiments, when the appliance 14 is plugged into the voltage supply 22 and the appliance ON/OFF switch (i.e., the appliance operation and monitoring module 34) is set to an ON position, the timer module power supply 78 and fan timer board 82 are powered (e.g., receive electrical current).

The fan timer board 82 is structured and operable to monitor the operation of the appliance 14 (e.g., the brew cycle of a coffee maker) via a relay and bridge rectifier 86. When operation of the appliance 14 is initiated via the appliance operation and monitoring module/appliance ON/OFF switch 34, the relay and bridge rectifier 86 energizes sending the trigger signal to the fan timer board 82, which sends 120 VAC to the steam/heat dispersion fan 26 thereby initiating operation of the steam/heat dispersion fan 26 for a preset or predetermined fan-on time cycle or duration (e.g., approx. 20 minutes), as controlled by the fan timer board 82 within the timer module 46. The steam/heat dispersion fan 26 is positioned or oriented to cool and disperse and direct steam and/or heat away from the appliance 14 and more particularly away from cabinets or any other object disposed above or near or adjacent or in close proximity to the appliance 14. For example, the steam/heat dispersion fan 26 will disperse the upward convection flow steam and/or heat from the appliance 14 and cool and direct the steam and/or heat away from cabinets or any other object disposed above or near or adjacent or in close proximity to the appliance 14. More particularly, the steam/heat dispersion fan 26 is integrated with the appliance such that it is positioned or oriented so that the steam and/or heat dispersion is completely automatic and requires no intervention during operation of the appliance 14.

At the end of the preset or user programmable fan-on time cycle or duration the timer module 46 (e.g., the fan timer board 82) interrupts, terminates, ceases or discontinues the flow of current therethrough, thereby ceasing the voltage being supplied to the steam/heat dispersion fan 26 and turning off operation of the steam/heat dispersion fan 26. In various embodiments, the timer module 46 (e.g., the fan timer board 82) can be configured to have a fixed preset/predetermined fan-on time cycle or duration (such as 20 minutes) for which the timer module 46 (e.g., the fan timer board 82) provides current to the steam/heat fan 26. In alternative embodiments, the timer module 46 (e.g., the fan timer board 82) can be configured to have a user adjustable or programmable variable fan-on time cycle or duration, such that the timer module 46 (e.g., the fan timer board 82) can be set or programmed to by the application user to have a user controlled fan-on time cycle or duration (e.g., 10, 20, 30, etc. minutes). In various embodiments of the appliance exemplarily shown in FIG. 5, it is envisioned that that the appliance 14 can include a steam/heat fan ON/OFF indicator LED light that illuminates when the steam/heat dispersion fan 26 is operating.

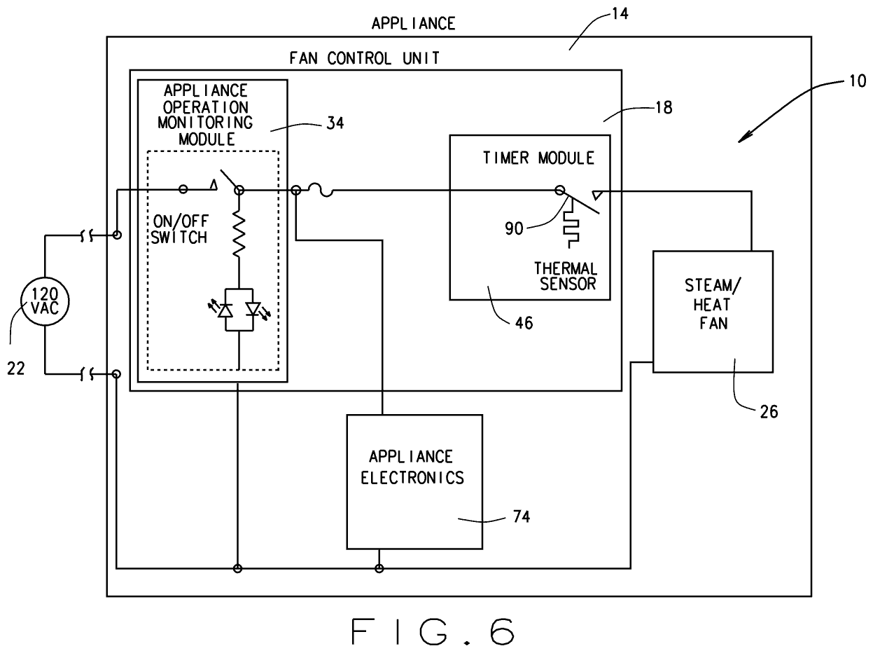

FIG. 6 provides an exemplary basic electrical schematic wherein fan control unit 18 and steam/heat dispersion fan 26 are both integrated into the appliance 14 in accordance with various other embodiments of the present disclosure. In various instances of such embodiments the appliance operation and monitoring module 34 can comprise an appliance ON/OFF switch (e.g., a light indicating start switch), and the timer module 46 can comprise a thermal sensor 90 strategically disposed, positioned or placed in the known path that the steam/heat generated by the appliance 14 exits the appliance 14. In such embodiments when the appliance 14 is connected to (e.g., plugged into) the voltage supply source 22 and the appliance operation and monitoring module/appliance ON/OFF switch 34 is turned ON, the thermal sensor 90 monitors the steam and/or heat generated by the appliance 14 as the steam/heat passes over the thermal sensor 90. When steam and/or heat generated by the appliance 14 passing over the steam/vapor causes the thermal sensor to activate (e.g., close its contacts), the thermal sensor allows current to flow to the steam/heat dispersion fan 26, thereby activating the steam/heat dispersion fan 26 for a preset or predetermined fan-on time cycle or duration (e.g., approx. 20 minutes), as controlled by the fan timer board 82. Note that while the thermal sensor is a good monitor and can initiate the dispersion cycle, the appliance ON/OFF switch can also initiate the dispersion cycle.

The steam/heat dispersion fan 26 is positioned to cool and disperse and direct steam and/or heat away from the appliance 14 and more particularly away from cabinets or any other object disposed above or near or adjacent or in close proximity to the appliance 14. For example, the steam/heat dispersion fan 26 will disperse the upward convection flow steam and/or heat from the appliance 14 and cool and direct the steam and/or heat away from cabinets or any other object disposed above or near or adjacent or in close proximity to the appliance 14. More particularly, the steam/heat dispersion fan 26 is integrated with the appliance such that it is positioned or oriented so that the steam and/or heat dispersion is completely automatic and requires no intervention during operation of the appliance 14. As long as there is steam and/or heat is generated by the appliance 14 such that there is sufficient heat to keep the thermal sensor 90 activated (e.g., keep the thermal sensor 90 contacts closed) the steam/heat dispersion fan 26 will operate to disperse the steam and/or heat generated by the appliance 14. When the appliance 14 no longer generated sufficient heat to keep the thermal sensor 90 activated, the thermal sensor 90 contacts will open and operation of the steam/heat dispersion fan 26 will cease.

At the end of the preset or user programmable fan-on time cycle or duration the timer module 46 (e.g., the thermal sensor 90) interrupts, terminates, ceases or discontinues the flow of current therethrough, thereby ceasing the voltage being supplied to the steam/heat dispersion fan 26 and turning off operation of the steam/heat dispersion fan 26. In various embodiments, the timer module 46 (e.g., the thermal sensor 90) can be configured to have a fixed preset/predetermined fan-on time cycle or duration (such as 20 minutes) for which the timer module 46 (e.g., the thermal sensor 90) provides current to the steam/heat fan 26. Additionally, other embodiments can be set up where both the timer module 46 and the thermal sensor 90 must open their circuit to allow the steam/heat dispersion fan 26 to be turned off. In alternative embodiments, the timer module 46 (e.g., the thermal sensor 90) can be configured to have a user adjustable or programmable variable fan-on time cycle or duration, such that the timer module 46 (e.g., the thermal sensor 90) can be set or programmed to by the application user to have a user controlled fan-on time cycle or duration (e.g., 10, 20, 30, etc. minutes).

It should be understood that the components exemplarily described above and exemplarily illustrated in the figures (e.g., the power supply of timer module 78, the fan time board 82 and the relay and bridge rectifier 86 of the timer module 46, etc.) are only exemplary components of the respective module or unit (e.g., the appliance operation and monitoring module 34, the timer module 46, the fan control unit 18, etc.) and the respective module or unit should not be limited to such components. Rather, the respective module or unit can comprise any other combination of suitable components known to one skilled in the art to perform the function of the respective module or unit as described above and remain within the scope of the present disclosure.

Additionally, it should be noted that any and all of the various components exemplarily described above and illustrated in various figures, e.g., the fan control unit ON/OFF switch 58, the appliance operation monitoring/appliance ON/OFF switch 34, the appliance operation monitoring/current sensing module 34, the timer module time delay drop out relay board 66, the timer module fan timer board 82, the timer module thermal sensor 90 are not limited in their use, implementation or application to only the exemplary embodiment in which the respective component is described and illustrated. More specifically, it is envisioned that any and all of the various components exemplarily described above and illustrated in various figures can be used, implemented and applied to and/or within any of the various other embodiments exemplarily described and illustrated, as would be clearly, readily and easily understood by one skilled in the art. Still more specifically, it is envisioned that any and all of the various components exemplarily described above and illustrated in various figures can be substituted for like or corresponding components exemplarily described above and illustrated in various figures as would be clearly, readily and easily understood by one skilled in the art. Furthermore, the present disclosure is by no means limited to only having current, voltage, and thermal as the only means of triggering the timer module 46. It is envisioned that in various embodiments infrared signals can trigger the timer module 46.

The description herein is merely exemplary in nature and, thus, variations that do not depart from the gist of that which is described are intended to be within the scope of the teachings. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the disclosure. Such variations and alternative combinations of elements and/or functions are not to be regarded as a departure from the spirit and scope of the teachings.

What is claimed is:

1. An appliance steam and heat dispersion system, said system comprising:
a steam and heat dispersion fan structured and operable to generate forced air to disperse steam and heat generated by an appliance away from the appliance; and
a fan control unit structured and operable to detect operation of the appliance and activate the steam and heat dispersion fan upon detection of the operation of the appliance.

2. The system of claim 1, wherein the steam and heat dispersion fan and the appliance are removably connectable to the fan control unit.

3. The system of claim 2, wherein the fan control unit comprises:
an appliance operation and monitoring module that is structured and operable to detect operation of the appliance; and
a timer module that is communicatively connected to the appliance operation and monitoring module and is structured and operable to receive a trigger signal from the appliance operation and monitoring module and activate the steam and heat dispersion fan upon detection of the operation of the appliance.

4. The system of claim 3, wherein the appliance operation and monitoring module is structured and operable to sense current flowing through the appliance operation and monitoring module to the appliance when the appliance is in use and send the trigger signal to the timer module when the sensed current exceeds a set threshold thus activating the steam and heat dispersion fan.

5. The system of claim 4, wherein the timer module comprises a time delay drop out relay board that is structured and operable to control a fan-on time cycle flow of current to the steam and heat dispersion fan upon receipt of the trigger signal.

6. The system of claim 1, wherein the steam and heat dispersion fan and the fan control unit are incorporated as part of the appliance.

7. The system of claim 6 wherein the fan control unit comprises:
an appliance operation and monitoring module that is structured and operable to detect operation of the appliance; and
a timer module that is communicatively connected to the appliance operation and monitoring module and is structured and operable to receive a trigger signal from the appliance operation and monitoring module and activate the steam and heat dispersion fan upon detection of the operation of the appliance.

8. The system of claim 7, wherein the appliance operation and monitoring module comprises an appliance ON/OFF switch structured and operable to turn the appliance On and Off and to send the trigger signal to the timer module.

9. The system of claim 8, wherein the timer module comprises a fan time board and a relay and bridge rectifier that are structured and operable to control a fan-on time cycle flow of current to the steam and heat dispersion fan upon receipt of the trigger signal.

10. The system of claim 8, wherein the timer module comprises a thermal sensor that is structured and operable to control a fan-on time cycle flow of current to the steam and heat dispersion fan upon receipt of the trigger signal.

11. A steam and heat dispersion fan control unit structured and operable to detect operation of an appliance removably connectable thereto and to activate a steam and heat dispersion fan removably connectable thereto upon detection of the operation of the appliance, said unit comprising;
an appliance operation and monitoring module that is structured and operable to detect operation of the appliance; and
a timer module that is communicatively connected to the appliance operation and monitoring module and is structured and operable to receive a trigger signal from the appliance operation and monitoring module and activate a steam and heat dispersion fan upon detection of the operation of the appliance, the steam and heat dispersion fan structured and operable to generate forced air to disperse the at least one of steam and heat generated by an appliance away from the appliance.

12. The unit of claim 11, wherein the appliance operation and monitoring module is structured and operable to sense current flowing through the appliance operation and monitoring module to the appliance when the appliance is in use and send the trigger signal to the timer module the sensed current exceeds a set threshold.

13. The unit of claim 12, wherein the timer module comprises a time delay drop out relay board that is structured and operable to control a fan-on time cycle flow of current to the steam and heat dispersion fan upon receipt of the trigger signal.

14. An appliance that generates at least one of steam and heat during operation and is structured and operable to generate forced air to disperse the at least one of steam and heat away from the appliance, said appliance comprising:
appliance electronics; and
an appliance steam and heat dispersion system, wherein the appliance steam and heat dispersion system comprising:
a steam and heat dispersion fan structured and operable to generate forced air to disperse the at least one of steam and heat generated by an appliance away from the appliance; and
a fan control unit structured and operable to detect operation of the appliance and activate the steam and heat dispersion fan upon detection of the operation of the appliance.

15. The appliance of claim 14, wherein the fan control unit comprises:
an appliance operation and monitoring module that is structured and operable to detect operation of the appliance; and
a timer module that is communicatively connected to the appliance operation and monitoring module and is structured and operable to receive a trigger signal from the appliance operation and monitoring module and activate the steam and heat dispersion fan upon detection of the operation of the appliance.

16. The appliance of claim 15, wherein the appliance operation and monitoring module is structured and operable to sense current flowing through the appliance operation and monitoring module when the appliance is in use and send the trigger signal to the timer module when the sensed current exceeds a set threshold.

17. The appliance of claim 16, wherein the timer module comprises a time delay drop out relay board that is structured and operable to control a fan-on time cycle flow of current to the steam and heat dispersion fan upon receipt of the trigger signal.

18. The appliance of claim 15, wherein the appliance operation and monitoring module comprises an appliance ON/OFF switch structured and operable to turn the appliance On and Off and to send the trigger signal to the timer module.

19. The appliance of claim 18, wherein the timer module comprises a fan time board and a relay and bridge rectifier that are structured and operable to control a fan-on time cycle flow of current to the steam and heat dispersion fan upon receipt of the trigger signal.

20. The appliance of claim 18, wherein the timer module comprises a thermal sensor that is structured and operable to control a fan-on time cycle flow of current to the steam and heat dispersion fan upon receipt of the trigger signal.
